(19) United States
(12) Patent Application Publication
(10) Pub. No.: US 2016/0321279 A1
(43) Pub. Date: Nov. 3, 2016

(54) DATA PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Hiroyasu ISHIJIMA, Kanagawa (JP)

(73) Assignee: FUJI XEROX CO., LTD., Tokyo (JP)

(21) Appl. No.: 14/881,403

(22) Filed: Oct. 13, 2015

(30) Foreign Application Priority Data
Apr. 28, 2015 (JP) 2015-092103

(51) Int. Cl. G06F 17/30; G06F 11/14

(52) U.S. Cl. CPC G06F 17/30088; G06F 11/1451; G06F 2201/80

(57) ABSTRACT

Provided is a data processing apparatus including a first generation section that generates first format data as data in a first format in relation to the document element and stores the generated first format data in a first storage section, the first generation section omitting generation of the first format data in relation to the document element, and a second generation section that generates second format data as data in a second format to which a number of depiction parameters larger than a number of depiction parameters of the first format data are applied and stores the generated second format data in a second storage section in association with the document element and identification information corresponding to a combination of the depiction parameters for reuse, the second generation section omitting generation of the second format data in relation to the combination.

### CROSS-REFERENCE TO RELATED APPLICATIONS

This application is based on and claims priority under 35 USC 119 from Japanese Patent Application No. 2015-092103 filed Apr. 28, 2015.

### BACKGROUND

(i) Technical Field

The present invention relates to a data processing apparatus and a non-transitory computer readable medium storing a program.

(ii) Related Art

Among systems that generate image data (hereinafter, referred to as “raster data”) in a raster (bitmap) format, which is to be supplied to a printing device, from document data (hereinafter, referred to as “PDL data”) described in a page description language (PDL), there is a system that employs a two-stage conversion scheme in which the PDL data is once converted into intermediate data and the intermediate data is then converted into raster data. The individual objects described in the PDL data have high degrees of abstraction in a sense that the objects do not depend on depiction conditions (a collective term of operations and features thereof; also referred to depiction parameters) such as operations including rotation, enlargement, and reduction applied to the objects and physical features (such as resolution and color spaces, for example) of the printing device. In contrast, it is possible to state that the raster data has a low degree of abstraction in a sense that the depiction conditions are reflected and the raster data may immediately be used for printing by a specific printing device. On the other hand, there are formats of intermediate data with various degrees of abstraction, such as intermediate data in a format that is similar to the PDL and intermediate data in a format that is similar to the raster data printed by the printing device. A level of abstraction of an intermediate data format is selected depending on the system design concept.

Among print data processing systems in the related art, there is a system configured such that intermediate data or raster image data of objects (document elements configuring a document) generated by interpreting PDL data is stored in a cache and the data stored in the cache is reused when the same objects appear again to omit the processing of generating the data and to thereby increase the processing speed.

### SUMMARY

According to an aspect of the invention, there is provided a data processing apparatus including:

a first generation section that generates, based on a result of interpretation obtained by interpreting page description language data of a document element, first format data as data in a first format in relation to the document element and stores the generated first format data in a first storage section, the first generation section omitting generation of the first format data in relation to the document element when the first format data in relation to a same document element has already been stored in the first storage section; and

a second generation section that generates, based on the first format data in relation to the document element stored in the first storage section, second format data as data in a second format to which a number of depiction parameters larger than a number of depiction parameters of the first format data are applied and stores the generated second format data in a second storage section in association with the document element and identification information corresponding to a combination of the depiction parameters for reuse, the second generation section omitting generation of the second format data in relation to the combination when the second format data associated with the identification information corresponding to the combination has already been stored in the second storage section.

### BRIEF DESCRIPTION OF THE DRAWINGS

Exemplary embodiments of the present invention will be described in detail based on the following figures, wherein:

FIG. 1 is a diagram illustrating an exemplary printing system to which an RIP module according to an exemplary embodiment is employed;

FIG. 2 is a diagram illustrating an exemplary embodiment of the RIP module;

FIG. 3 is a diagram illustrating an exemplary procedure for processing of the RIP module according to the exemplary embodiment;

FIG. 4 is a diagram illustrating an exemplary procedure for processing performed by a cache mechanism;

FIG. 5 is a diagram illustrating an exemplary configuration of an RIP module according to a first modification example;

FIG. 6 is a diagram illustrating an exemplary procedure for processing performed by the RIP module according to the first modification example;

FIG. 7 is a diagram illustrating an exemplary configuration of an RIP module according to a second modification example;

FIG. 8 is a diagram illustrating an exemplary procedure for processing performed by an RIP module according to a third modification example;

FIG. 9 is a diagram illustrating an exemplary configuration of the RIP module according to the third modification example;

FIG. 10 is a diagram illustrating another exemplary configuration of the RIP module according to the third modification example;

FIG. 11 is a diagram illustrating an exemplary configuration of an RIP module according to a fourth modification example;

FIG. 12 is a diagram illustrating exemplary content of data in a cache entry table that is used in the fourth modification example;

FIG. 13 is a diagram illustrating an exemplary procedure for processing performed by a cache mechanism according to the fourth modification example;

FIG. 14 is a diagram illustrating an exemplary procedure for processing performed by a cache management unit;

FIG. 15 is a diagram illustrating an exemplary configuration of an RIP module according to a fifth modification example; and

FIG. 16 is a diagram illustrating an exemplary procedure for processing performed by the RIP module according to the fifth modification example.

### DETAILED DESCRIPTION

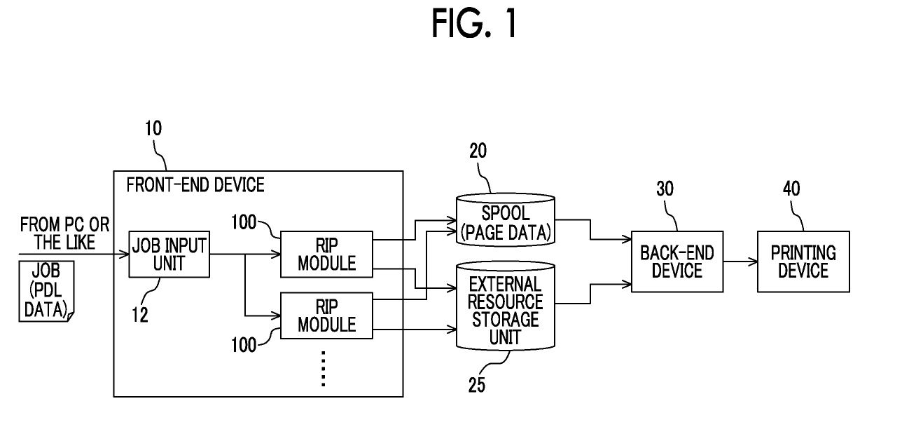

A description will be given of an exemplary printing system to which an RIP module 100 according to an exemplary embodiment is applied, with reference to FIG. 1.

The printing system illustrated in FIG. 1 includes a front-end device 10, a spool 20, an external resource storage unit 25, a back-end device 30, and a printing device 40.

The front-end device 10 is a device that converts a printing job, namely PDL data that is input from a client device such as a personal computer (PC) into intermediate data. The front-end device 10 includes a job input unit 12 and one or more RIP modules 100. In a typical example, the front-end device 10 is a computer, and the job input unit 12 and the individual RIP modules 100 are different processes that the computer executes.

The job input unit 12 receives PDL data from the client device and requests the RIP modules 100 to process the PDL data. When plural RIP modules 100 are present in the front-end device 10, the job input unit 12 allocates the processing of the PDL data to the respective RIP modules 100 in a unit of output and causes the respective RIP modules 100 to execute the allocated processing. The unit of output is, for example, a page or a band (plural strip-shaped regions obtained by dividing one page in a sub-scanning direction).

The RIP modules 100 interpret the PDL data allocated by the job input unit 12, generate intermediate data, and output the intermediate data to the spool 20 in the later stage. The intermediate data output by the RIP modules 100 to the spool 20 is in the intermediate data format to which a relatively large number of depiction parameters are applied (in other words, a degree of abstraction is relatively low).

Here, the “depiction parameters” are parameters on which a depiction state of objects on raster data for the printing device depends. Plural depiction parameters are present. Examples of the depiction parameters include a coordinate conversion matrix, various depiction attributes, clip information, and color information. The coordinate conversion matrix is a matrix for converting a coordinate system of an image in the PDL data into a coordinate system of an image in the printing device. In a case of rotating, enlarging, or reducing the image represented in the PDL when the image is printed, a component of the rotation, the enlargement, or the reduction is reflected to the coordinate conversion system. Examples of the depiction attributes include a line width, a line cap, line join, a miter limit, a line shape, stroke adjustment, a depiction scheme, a logical operation mode, and pattern information. The clip information is information of a path, a mask, and the like that define a part of an image to be clipped (cut out) and printed. In a case of using PostScript (registered trademark) as a PDL, for example, the respective parameters included in the “Graphic State” of PostScript are examples of the depiction parameters in the exemplary embodiment. The above depiction parameters are described only for illustrative purposes.

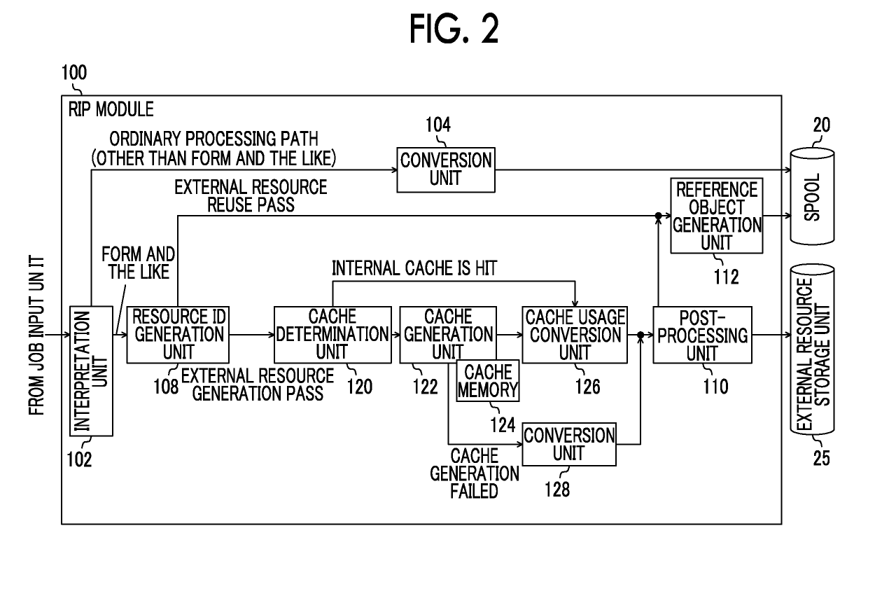

In the following description, the format of the data, which is output from the RIP module 100 to the spool 20, to which a relatively large number of depiction parameters are applied, will be referred to as an “external format” in the sense that the format is a format of data output to the “external” device of the RIP module 100, for convenience. The RIP module 100 according to the exemplary embodiment includes an internal cache memory 124 (see FIG. 2) for reusing a processing result inside the module itself, as will be described later. The internal cache memory 124 stores intermediate data with a higher degree of abstraction than that of the external format. The “higher degree of abstraction” means that the number of depiction parameters applied is smaller than that of the external format. That is, only apart of the depiction parameters, which are applied to a corresponding external resource, is applied or no depiction parameters are applied to the intermediate data stored in the cache memory 124. The format of the intermediate data stored in the cache memory 124 will be referred to as an “internal format” for distinguishing the format from the external format. In addition, details of the RIP module 100 according to the exemplary embodiment including usage of the cache memory 124 will be described later with reference to FIG. 2 and the like.

In an example, the internal format and the external format may have the same object granularity (that is, the former object and the latter object have a one-to-one correspondence) and have different degrees of abstraction though not limited thereto.

The RIP module 100 has a function of outputting, to the external resource storage unit 25, the intermediate data in the external format that is generated for a specific type of object, such as a form, which is repeatedly used in a document (which is reused in many opportunities) as an external resource. “External” of the “external resource” has the same meaning as that of “external” of the “external format”. When an external resource corresponding to the specific type of object, which is detected from PDL data, is not stored in the external resource storage unit 25, the RIP module 100 generates intermediate data in the external format for the object and registers the intermediate data in the external resource storage unit 25 in association with identification information (which will be referred to as an “external resource ID”) for identifying the external resource. When the external resource corresponding to the specific type of object, which is detected from the PDL data, is stored in the external resource storage unit 25, the RIP module 100 does not perform generation of the intermediate data in the external format for the object (and the registration of the intermediate data in the external resource storage unit 25).

The RIP module 100 generates intermediate data in the external format for each page (logical page) of the PDL data and outputs the generated intermediate data to the spool 20 outside the RIP module 100. At this time, a command (reference object) in the external format of referring to the external resource corresponding to the object is output for the specific type of object as a target of usage of the external resource, which is included in each page, instead of the data in the external format representing the object. The reference object includes, for example, an external resource ID for specifying the external resource.

Since an object of intermediate data typically has finer granularity than that of the PDL, an object of the PDL is divided into plural objects in the intermediate data in the external format in some cases. In such cases, the RIP module 100 regards the plural objects in the external format, which are obtained as a result of converting the PDL object, as a group and registers the group in the external resource storage unit 25 in association with an external resource ID that is generated so as to correspond to the PDL object. In doing so, plural necessary objects in the external format may be searched for based on the external resource ID.

The back-end device 30 generates print image data (typically, raster data), which may be handled by the printing device 40, for each page of a document as a target of printing that is accumulated in the spool 20 by sequentially processing intermediate data (external format) of each page of the document. When a reference object that calls an external resource from the intermediate data of each page is detected at this time, the back-end device 30 generates the print image data corresponding to the external resource by reading, from the external resource storage unit 25, the external resource corresponding to the external resource ID included in the reference object, and processing the external resource (which is intermediate data in the external format). The back-end device 30 sequentially outputs the thus generated print image data for each page to the printing device 40. Since the function of the back-end device 30 may be the same as that in the related art, further descriptions will be omitted.

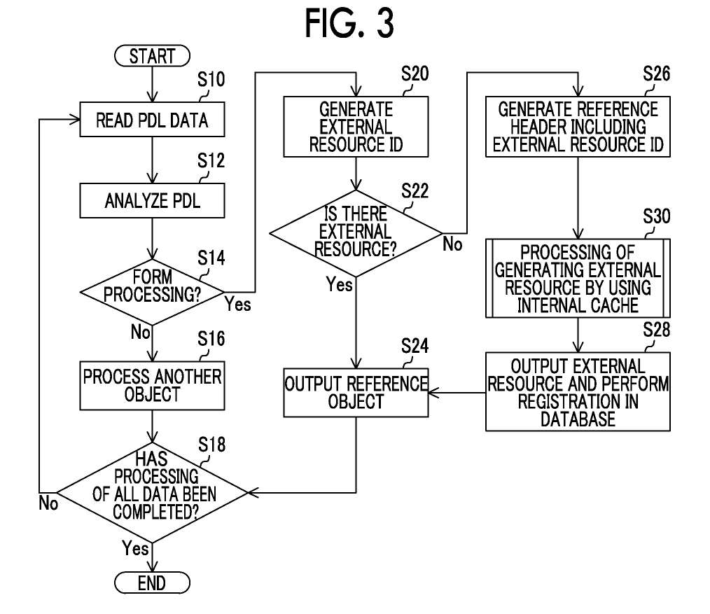

Next, a description will be given of a functional configuration and operations of the RIP module 100 according to the exemplary embodiment with reference to FIGS. 2 and 3.

As illustrated in FIG. 2, the RIP module 100 includes an interpretation unit 102, a conversion unit 104, a resource ID generation unit 108, a post-processing unit 110, a reference object generation unit 112, a cache determination unit 120, a cache generation unit 122, the cache memory 124, a cache usage conversion unit 126, and a conversion unit 128.

The interpretation unit 102 receives allocation of processing targets in a unit of output from the job input unit 12, then sequentially reads a command from the head of PDL data in the unit of output (step S10 in FIG. 3) and analyzes the command read by the interpretation unit 102 (step S12). In the analysis processing, language analysis such as lexical analysis and syntax analysis is performed on the PDL data of the read command, and results of the analysis are allocated to processing modules in later stages. The interpretation unit 102 determines whether or not the command is a target (a form or the like) of usage of an external resource in accordance with each result of the analysis of the command (object) (step S14). When the command is determined to be a target of usage of an external resource, the result of analysis for the object is passed to the resource ID generation unit 108 (to step S20). In contrast, when the command is determined not to be a target of usage of an external resource, the result of the analysis for the command is passed to the conversion unit 104 on an ordinary processing pass (step S16). Here, the processing in relation to an external resource is considered to be special processing, and processing for other commands is referred to as ordinary processing.

The conversion unit 104 converts an ordinary command into intermediate data in the external format in accordance with a result of the language analysis of an ordinary command for processing other than processing in relation to an external resource, which is received from the interpretation unit 102, and outputs the intermediate data as a result of the conversion to the spool 20 (step S16). The processing performed by the conversion unit 104 may be the same as that in the related art. Thereafter, it is determined whether or not processing of the allocated last part of the PDL data has been completed (step S18). When the processing has not been completed, the processing returns to step S10 to read the next command from the PDL data.

The resource ID generation unit 108 uses the result of analyzing the object as a target of usage of an external resource, which is received from the interpretation unit 102, to generate an external resource ID corresponding to the object (step S20).

The external resource ID corresponding to the object as a target of usage of an external resource is generated as a combination of an ID (such as a form ID in PostScript) of the object included in the PDL data and a depiction parameter group that is applied to the object for usage of the external resource. For example, data to which the depiction parameter group to be applied to the form object is added after the form ID in an order determined in advance, a hash value of the data is obtained, and the hash value is regarded as the external resource ID. The thus generated external resource ID is a constant value for external resources that are generated by applying the same depiction parameter group to the same object (form). That is, intermediate data (external format) as a result of conversion becomes different depending on internal states (the internal states vary as the PDL data is interpreted in the order from the head) of the RIP module 100 when objects are converted into the external format even when the objects (forms) are described in completely the same manner in the PDL data. In other words, different external resource IDs are allocated by reflecting the depiction parameter groups configuring the internal states to the external resource IDs. In addition, a hash value is used as an external resource ID for convenience of generating an ID with an appropriate amount of data. Original data (obtained by adding the depiction parameter group to the form ID) before obtaining the hash value may be regarded as an external resource ID as long as the amount of data thereof is acceptable by system processing capability.

In addition, the resource ID generation unit 108 determines whether or not an external resource corresponding to the generated external resource ID has been stored in the external resource storage unit 25 (step S22). The determination may be made by inquiring at the external resource storage unit 25 about whether or not the external resource ID has been registered, for example. When storage capacity of the external resource storage unit 25 is sufficiently large and an external resource that has been once registered in printing processing for one job is not deleted from the external resource storage unit 25, the external resource ID generated in the processing for the job may be stored in an internal database, and it may be determined that the external resource is present in the external resource storage unit 25 when the newly generated external resource ID is in the database.

When a result of the determination in step S22 is positive (Yes), the processing proceeds to an external resource reuse pass. In the external resource reuse pass, the same external resource is not generated again, and the external resource that has already been stored in the external resource storage unit 25 is reused. That is, the resource ID generation unit 108 passes the generated external resource ID to the reference object generation unit 112 in this case. The reference object generation unit 112 generates a command (reference object) in the external format referring to the external resource ID and outputs the command to the spool 20 (step S24). Then, the processing proceeds to step S18 and then returns to step S10 when the processing of the last part of the PDL data has not been completed.

When the result of the determination in step S22 is negative (No), the processing proceeds to an external resource generation pass. In the external resource generation pass, an external resource corresponding to the object is newly generated and is registered in the external resource storage unit 25. In such a case, the resource ID generation unit 108 generates a reference header to be added to an external resource that is to be generated from this point (step S26). The reference header includes the external resource ID. It becomes possible to search for the generated external resource by using the external resource ID as a key by adding the reference header to the external resource and registering the external resource in the external resource storage unit 25.

In the processing of the external resource generation pass, components from the cache determination unit 120 to the conversion unit 128 perform the processing of generating the external resource by using an internal cache (step S30). In the external resource generation pass, a two-stage generation procedure is performed. That is, the cache generation unit 122 generates intermediate data in the internal format which has a higher degree of abstraction than that of the external resource, from a result of the interpretation of the PDL data, and the cache usage conversion unit 126 generates the external resource by further applying the depiction parameters to the intermediate data in the internal format. Then, efficiency of the processing in the external resource generation pass is improved by storing the intermediate data in the internal format, which is generated by the cache generation unit 122, as cache data in the cache memory 124 and reusing the intermediate data. The generated external resource is passed to the post-processing unit 110.

The post-processing unit 110 registers the received external resource (including the reference header) in the external resource storage unit 25 (step S28). At this time, the external resource ID may be registered in a database for internal searching (which is referred to when the resource ID generation unit 108 determines whether or not the external resource has been generated). Then, the post-processing unit 110 passes the external resource ID to the reference object generation unit 112. The reference object generation unit 112 generates a reference object referring to the external resource ID and outputs the reference object to the spool 20 (step S24). The reference object is correctly recognized since the external resource registered in S28 is stored in the external resource storage unit 25 at the timing when the back-end device 30 processes the reference object output at this time. After S24, the processing proceeds to step S18 and then returns to step S10 when the processing of the last part of the PDL data has not been completed.

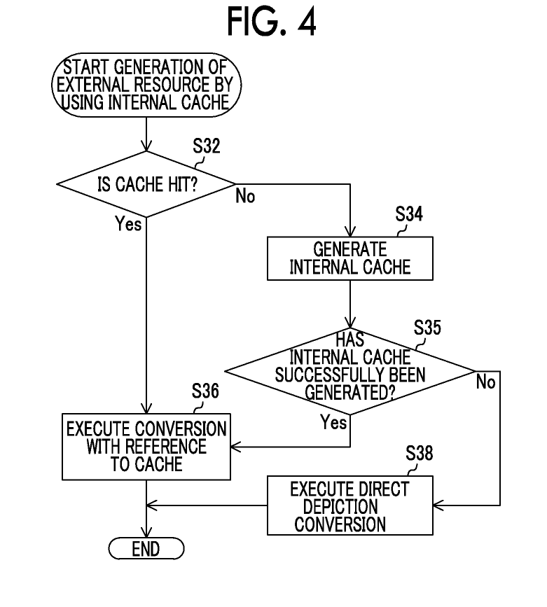

Next, a description will be given of exemplary functions of the components from the cache determination unit 120 to the conversion unit 128 and exemplary processing (processing of generating an external resource by using an internal cache) in step S30 executed by these modules, with reference to FIGS. 2 and 4.

As roughly described above, the cache generation unit 122 generates intermediate data in the internal format in this exemplary embodiment. The internal format is a format of intermediate data which has a higher degree of abstraction than that of the external format, that is, a smaller number of depiction parameters are applied thereto. In a typical example, the internal format is a format of intermediate data to which no depiction parameter is applied. In this example, the cache generation unit 122 splits an object in the PDL format, as a target of processing, and expresses the individual objects obtained as a result of the splitting in a language of the intermediate data. In another example, the intermediate data in the internal format is generated by applying only a predetermined part of the depiction parameters, which are applied to the external format, thereto. For example, intermediate data in the internal format is generated by applying only a coordinate conversion matrix from among plural depiction parameters that are applied to the external resource. The intermediate data in the intermediate format, which is generated by the cache generation unit 122, is stored in the cache memory 124 as internal cache data (“internal cache”) of the RIP module 100.

Since the internal cache has a higher degree of abstraction than that of the external resource, the possibility of reuse thereof is higher than that of the external resource. When no depiction parameter is applied to the internal cache corresponding to a specific object (PDL), for example, it is possible to generate an external resource by using the internal cache regardless of what kind of depiction parameters are applied to the object. In contrast, since the depiction parameter group has already been applied in the case of the external resource, the external resource is reused for an object to which a depiction parameter group that coincides with the applied depiction parameter group is applied.

In the processing of generating an external resource by using an internal cache, the cache determination unit 120 determines whether or not an internal cache corresponding to the object, which is designated as a target of the processing by the resource ID generation unit 108, is in the cache memory 124 (step S32).

When a result of the determination in step S32 is negative (No), the cache generation unit 122 generates the internal cache by processing a result of the PDL interpretation of the object (step S34) and stores the generated internal cache in the cache memory 124.

Here, the internal cache is stored in the cache memory 124 while a form ID obtained from a result of analyzing PDL data of the original object, for example, or identification information generated from the form ID is used as an index (referred to as a “cache ID”). In a case of converting an object in the PDL into plural objects in the internal format, it is only necessary to regard the plural objects in the internal format as a group and store the group in the cache memory 124 in association with the cache ID. The determination in step S32 is made by examining whether an entry corresponding to the cache ID obtained from the result of analyzing the PDL data of the object is present in the cache memory 124.

During the processing performed by the RIP module 100, an entity (such as an object name or an object dictionary) of the PDL data of the original object is placed in a memory space, and a pointer of the entity is the same for the objects that are the same in the PDL level. The pointer may be used as the cache ID of the internal cache corresponding to the object. According to the scheme, it is possible to store the internal cache of the object, the form ID of which is not described in the PDL data, in a cache memory 125 in an identifiable state.

When the internal cache is successfully generated and stored in S34 (the result of the determination in step S35 is “Yes”), the cache usage conversion unit 126 generates an external resource by referring to the internal cache and applying a necessary depiction parameter group (that is, a depiction parameter group that is not yet applied to the internal cache from among the depiction parameters that are to be applied to the external resource) to the internal cache (step S36). The generated external resource is passed to the post-processing unit 110. The processing performed by the post-processing unit 110 after receiving the external resource and the processing performed by the following functional modules are the same as those described above.

The cache generation unit 122 fails to generate an internal cache in some cases due to a shortage of available capacity of the cache memory 124, for example. When the cache generation unit 122 fails to generate the internal cache, the cache usage conversion unit 126 cannot generate an external resource. In such a case (the result of the determination in step S35 is No), the conversion unit 128 directly converts the result of the interpretation of the PDL data by the interpretation unit 102 into intermediate data in the external format (step S38) in the example illustrated in FIG. 2. The conversion will be referred to as “direct depiction conversion”. The processing of the direct depiction conversion is the same as the processing that is executed by the conversion unit 104 on the ordinary processing pass. The external resource generated by the direct depiction conversion is passed to the post-processing unit 110. The processing performed by the post-processing unit 110 and the following mechanisms is the same as that described above.

When the result of the determination in step S32 is positive (Yes), that is, when a cache is hit by the cache determination unit 120, the cache usage conversion unit 126 generates an external resource by reading the internal cache corresponding to the object from the cache memory 124 and further applying depiction parameters to the internal cache, and outputs the external resource to the post-processing unit 110 (step S36).

The exemplary embodiment of the present invention is described hitherto. Even when an external resource corresponding to an input object is not present in the external resource storage unit 25, it is possible to use an internal cache as long as the internal cache corresponding to the object is present in the cache memory 124 in this exemplary embodiment. Therefore, a processing load is reduced as compared with a case of generating the internal cache again. Since the internal cache has a higher degree of abstraction than that of the external resource, the internal cache is easily hit. In a case of generating a print image in which the plural same objects are arranged at different locations by being rotated at a different angle, for example, an external resource generated for a former object cannot be reused when an image of the following object at a different rotation angle (this is one of the depiction parameters) is generated. However, an internal cache that does not reflect the rotation angle may be used for depiction of the following object. That is, it is possible to generate the external resource (and thus raster data) of the object by applying the rotation angle of the following object to the internal cache in this case.

Since the conversion unit 128 generates an external resource even when the cache generation unit 122 fails to generate an internal cache in this exemplary embodiment, the external resource may be reused.

### First Modification Example

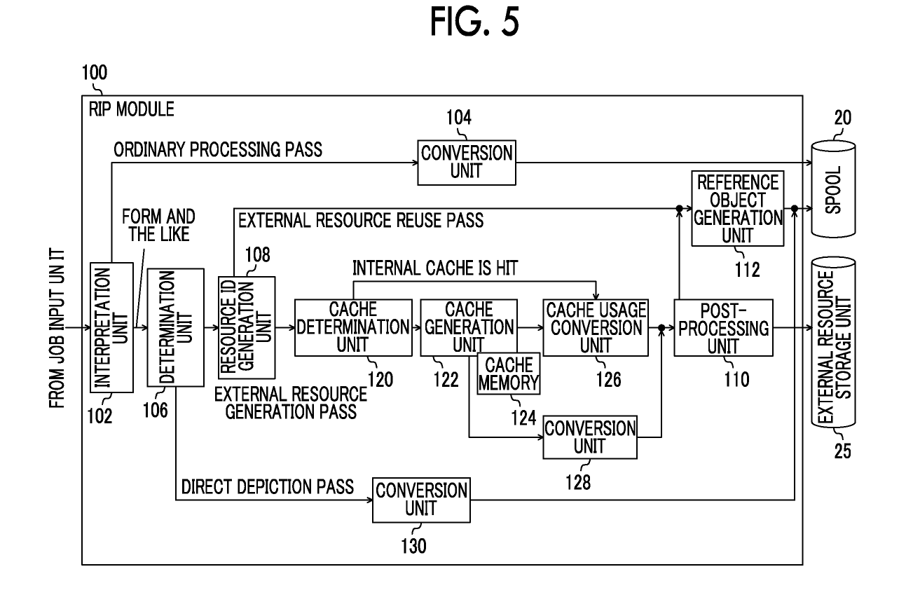

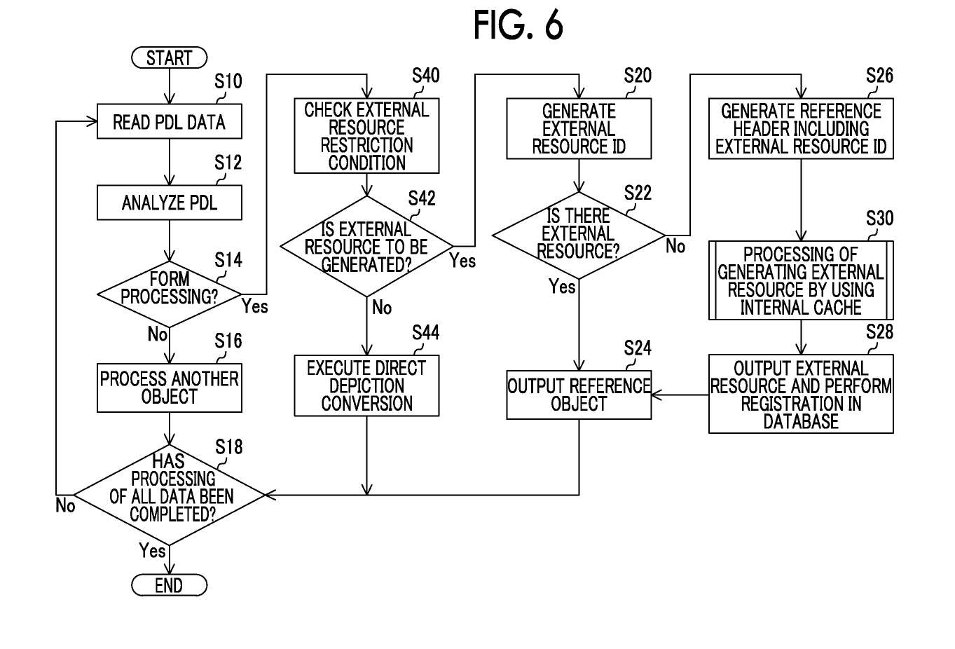

Next, a description will be given of a first modification example with reference to FIGS. 5 and 6. FIG. 5 illustrates a configuration example of the RIP module 100 according to the modification example, and FIG. 6 illustrates an exemplary procedure for processing performed by the RIP module 100 according to the modification example.

As may be understood from FIG. 5, the RIP module 100 according to the modification example is configured by adding a determination unit 106 and a direct depiction pass (conversion unit 130) to the RIP module 100 according to the aforementioned exemplary embodiment as illustrated in FIG. 2.

The direct depiction pass is a processing route employed when no external resource is generated for an object as a target of usage of an external resource, which satisfies specific conditions, and thus the external resource is not reused. As the conditions of employing the direct depiction pass, the following two may be considered, for example.

(a) An area or a data size is smaller than a predetermined threshold value.
(b) PDL data does not include identification information (a form ID and the like) of the object.

The condition (a) is the same as the condition of “a form that is not as a target of cache” in the related art. In relation to an object that meets the condition (a), it is considered that calculation cost required for generating an external resource, registering the external resource in the external resource storage unit 25, and reusing the external resource is higher than an advantage that may be achieved by reuse. Therefore, no external resource is generated.

For an object that meets the condition (b), it is difficult to generate an external resource ID of the external resource for the object. Therefore, no external resource is generated. Since the aforementioned external resource ID is generated by combining identification information of the object on the PDL data such as a form ID and a depiction parameter group, the external resource ID cannot be generated when the identification information of the object cannot be obtained from the PDL data. Even when the PDL data does not include the identification information of the object, it is considered to prepare the identification information of the object, as a source of the external resource ID, by a method of regarding the entire description of the PDL of the object as the identification in the worst case, for example. However, such method increases calculation cost.

When an object meets at least either the condition (a) or the condition (b) described above as a result of interpreting the object as a target of usage of an external resource, which is obtained from the interpretation unit 102, the determination unit 106 assigns the object to the direct depiction pass. An object that does not meet both the condition (a) and the condition (b) is sent to the resource ID generation unit 108 and assigned to the external resource reuse pass or the external resource generation pass in the same manner as in the exemplary embodiment illustrated in FIG. 2.

In the direct depiction pass, the conversion unit 130 directly converts the received result of analyzing the object into intermediate data in the external format (direct depiction conversion). The conversion processing performed by the conversion unit 130 may be the same as the processing performed by the conversion unit 104 in the ordinary processing pass.

The procedure for the processing according to the modification example as illustrated in FIG. 6 is obtained by adding Steps S40, S42, and S44 for the direct depiction pass to the procedure for processing according to the exemplary embodiment illustrated in FIG. 3. According to this procedure, the determination unit 106 checks whether or not the object, which has been determined to be a target of the usage of the external resource by the interpretation unit 102 (the result of the determination in step S14 is Yes) meets conditions (such as the aforementioned conditions (a) and (b)) for canceling generation of an external resource (step S40). When it is determined as a result of the checking that the object does not meet the conditions (a result of the determination in step S42 is Yes), the processing proceeds to step S20 to generate an external resource in the same manner as the processing according to the exemplary embodiment. In contrast, when it is determined that the object meets the conditions (the result of the determination in step S42 is No), the conversion unit 130 directly performs the conversion into the external format (step S44). The result of the conversion is output to the spool 20.

According to the first modification example, an increase in load is suppressed by not generating an external resource when there is a high possibility that generation and reuse of the external resource rather increases calculation load.

### Second Modification Example

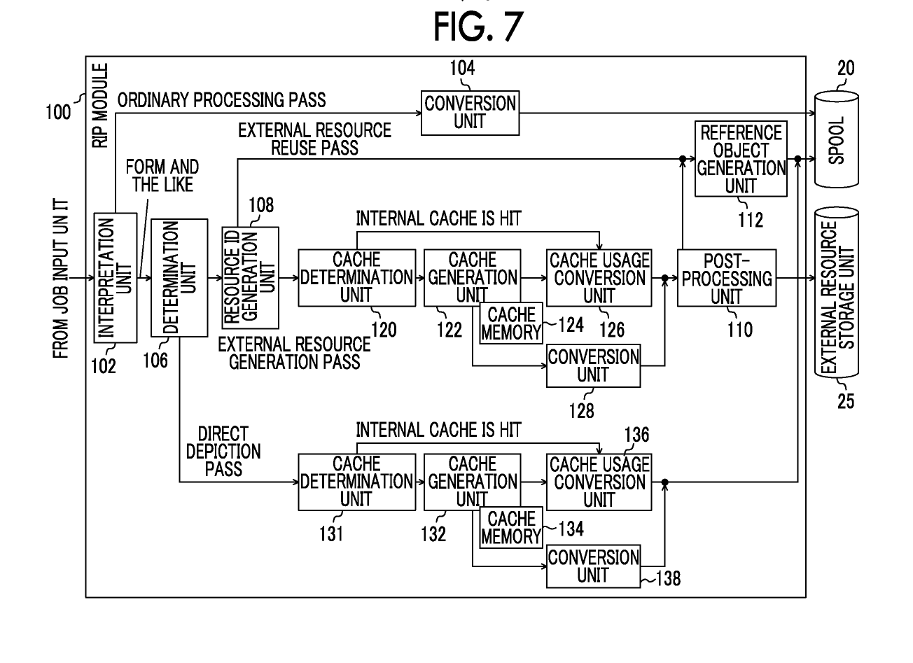

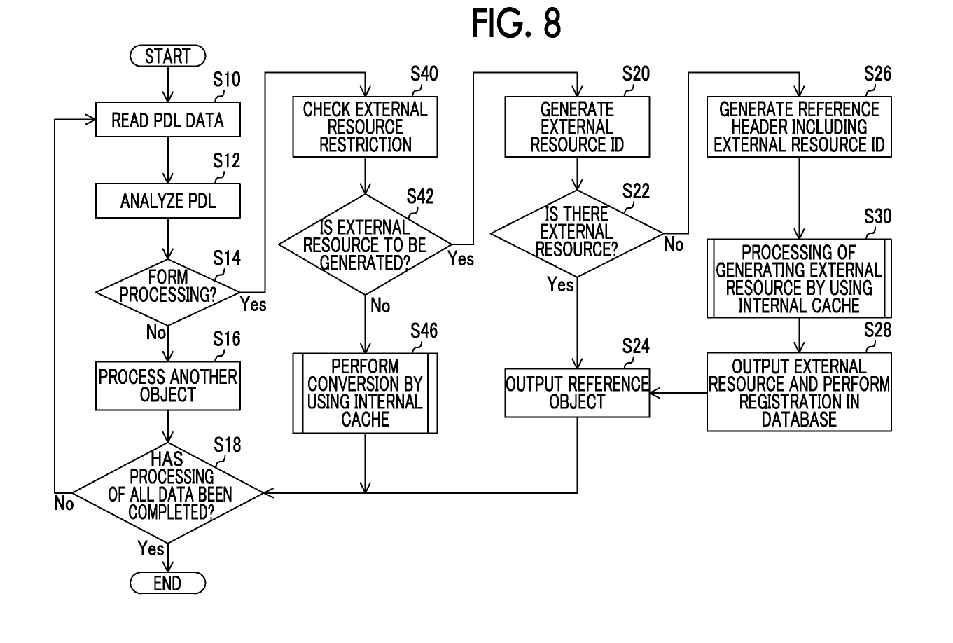

Next, a description will be given of a second modification example with reference to FIGS. 7 and 8. FIG. 7 illustrates a configuration example of an RIP module 100 according to the modification example, and FIG. 8 illustrates an exemplary procedure for processing performed by the RIP module 100 according to the modification example.

As may be understood from FIG. 7, the RIP module 100 according to the modification example is provided with the same cache mechanisms (cache determination unit 131 to conversion unit 138) as the cache mechanisms on the external resource generation pass, instead of the conversion unit 130 on the direct depiction pass according to the first modification example as illustrated in FIG. 5. Functions of a cache determination unit 131, a cache generation unit 132, a cache memory 134, a cache usage conversion unit 136, and a conversion unit 138 are the same as the functions of the cache determination unit 120, the cache generation unit 122, the cache memory 124, the cache usage conversion unit 126, and the conversion unit 128 on the external resource generation pass, respectively.

The procedure for the processing according to the modification example as illustrated in FIG. 8 is obtained by replacing Step S44 in the procedure for the processing according to the first modification example as illustrated in FIG. 6 with S46. Step S46 corresponds to processing of converting the result of interpreting the PDL data into an external format by using an internal cache, and in step S46, components from the cache determination unit 131 to the conversion unit 138 perform processing of the same procedure as that in Steps S32 to S38 illustrated in FIG. 4.

According to the second modification example, efficiency of the processing by using an internal cache is improved for not only an object as a target of the external resource generation pass but also an object as a target of the direct depiction pass.

### Third Modification Example

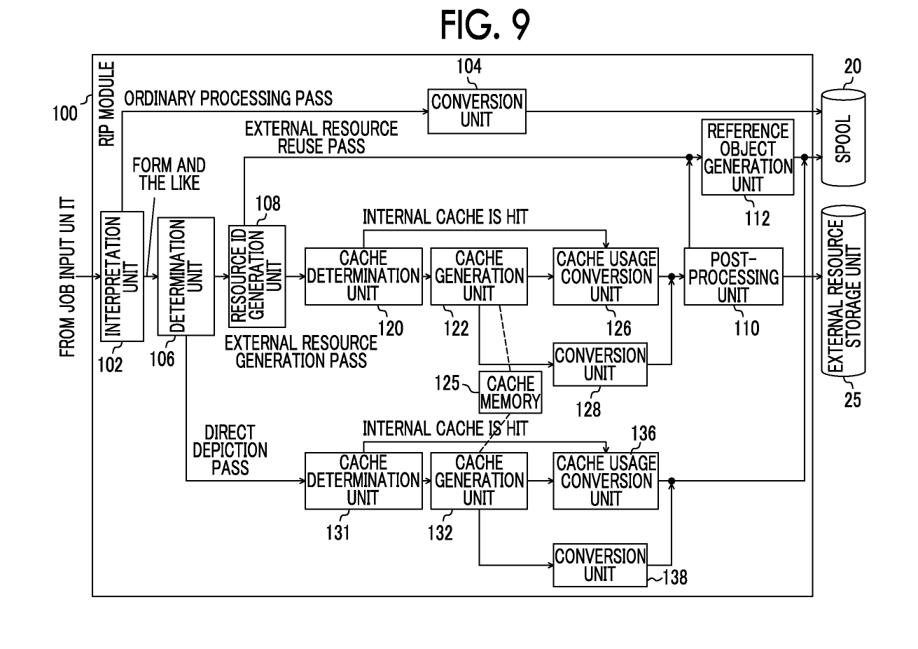

Next, a description will be given of a third modification example with reference to FIG. 9.

According to the aforementioned second modification example, the cache memories 124 and 134 for an internal cache are individually provided for the external resource generation pass and the direct depiction pass, respectively. In contrast, a single cache memory 125 is shared by both the passes in the third modification example. That is, the cache generation units 122 and 132 register generated internal caches in the common cache memory 125, and the cache usage conversion units 126 and 136 reads the internal caches from the common cache memory 125 and reuse the internal caches.

When an internal cache is once generated in one of the external resource generation pass and the direct depiction pass, the internal cache may also be reused for conversion in the other pass according to the modification example. When the cache generation unit 122 on the external resource generation pass generates an internal cache of a specific object in PDL data, and the following same object in the PDL data is passed to the direct depiction pass, for example, the cache usage conversion unit 136 uses the internal cache that is generated in the external resource generation pass and registered in the cache memory 125 to generate intermediate data in the external format.

Even when a description of an object A is completely the same as a description of an object B in PDL data (that is, both the object A and the object B are the same in the PDL level), for example, there may be a case in which the object A is passed to the external resource generation pass due to an area thereof that is equal to or greater than a threshold value while the object B is passed to the direct depiction pass due to an area thereof that is less than the threshold value since internal states (such as rates of enlargement or reduction or clipping setting) of the RIP module 100 differ from each other in the conversion of the object A and in the conversion of the object B. In such a case, the internal cache generated by the cache generation unit 122 on the external resource generation pass for the conversion of the object A is used later by the cache generation unit 132 on the direct depiction pass for the conversion of the object B via the common cache memory 125 in the modification example. In such a case, the load on the cache generation unit 132 is reduced by an amount corresponding to the processing of generating the internal cache.

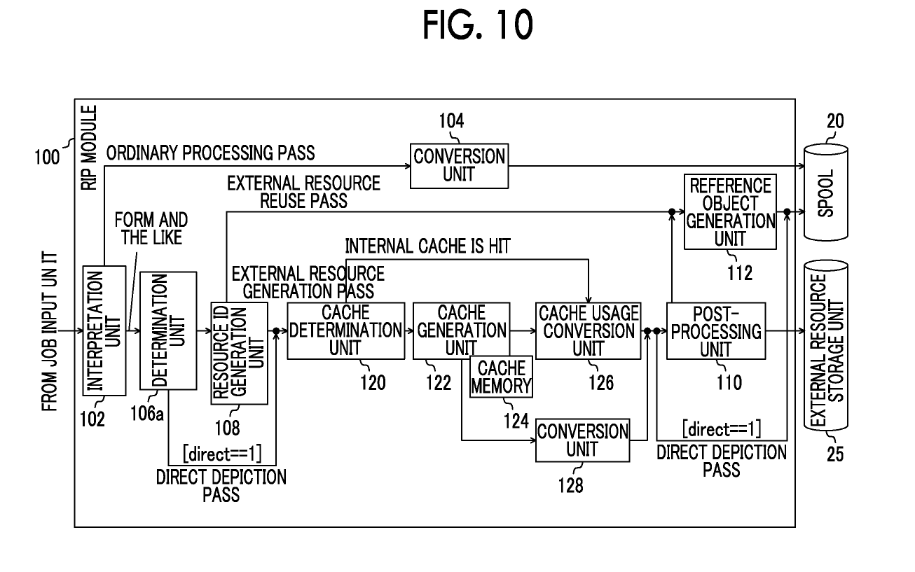

FIG. 10 illustrates another configuration for providing the same functions as those of the configuration illustrated in FIG. 9. Only a set of cache mechanisms (the cache determination unit 120 to the conversion unit 128) are provided in the configuration illustrated in FIG. 10 while the cache mechanisms are provided for the external resource generation pass and the direct depiction pass, respectively, in the configuration illustrated in FIG. 9. Instead, a bypass route that bypasses the resource ID generation unit 108 and reaches the cache determination unit 120 and a bypass route that bypasses the post-processing unit 110 and the reference object generation unit 112 and reaches the spool 20 are provided as direct depiction passes.

The determination unit 106a manages a “direct” flag for selecting a pass for processing an object. The “direct” flag may be a value “0” or a value “1”. When the “direct” flag is “1”, the direct depiction pass is selected. When the “direct” flag is “0”, a route other than the direct depiction pass is selected. When the determination unit 106a starts determination of a new object, the “direct” flag is reset to “0”. The determination unit 106a determines whether or not to send an object to the direct depiction pass by the same determination processing as that performed by the determination unit 106 according to the first modification example (see FIG. 5), and sets the value of the “direct” flag to “1” when the determination unit 106a determines to send the object to the direct depiction pass. When the “direct” flag is “1”, no external resource is generated since the resource ID generation unit 108 and the post-processing unit 110 are bypassed.

The configuration illustrated in FIG. 10 may further reduce a footprint of the RIP module 100 as compared with the configuration illustrated in FIG. 9 (save a calculator source, such as a memory, required for installation of the RIP module 100).

### Fourth Modification Example

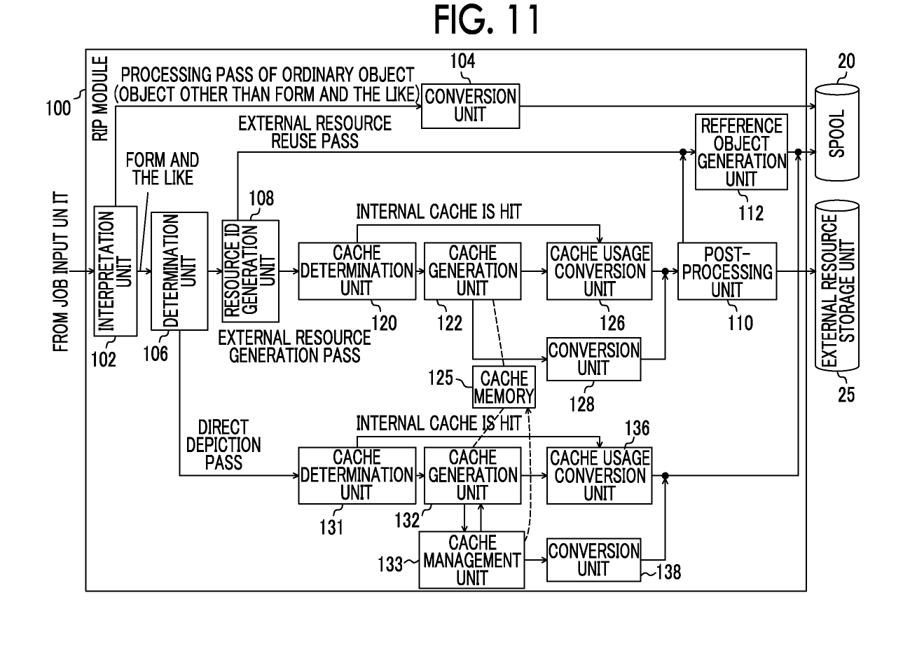

Next, a description will be given of a fourth modification example with reference to FIGS. 11 to 14. As may be understood from FIG. 11, the modification example may be achieved by adding a cache management unit 133 to the cache mechanisms in the direct depiction pass according to the third modification example as illustrated in FIG. 9.

The cache management unit 133 performs processing of deleting old data from the cache memory 125 to reserve available capacity required for generating an internal cache for a new object. In the deletion processing, internal caches generated in the external resource generation pass is deleted with priority from among the internal caches stored in the cache memory 125 that is shared by the external resource generation pass and the direct depiction pass. That is, when conditions other than the condition relating to which of the passes the internal caches are generated are the same, the internal caches generated in the external resource generation pass are deleted prior to the internal caches generated in the direct depiction pass. Even when the internal caches generated in the external resource generation pass are deleted, the external resources generated from the internal caches are stored in the external resource storage unit 25, and the external resources may be reused in the processing for the following objects. In contrast, there are no external resources corresponding to the internal caches generated in the direct depiction pass. Therefore, when the internal caches are deleted, data relating to the internal caches cannot be reused in the processing of the following objects. As described above, deletion of the internal caches generated in the direct depiction pass brings about more serious disadvantage (penalty) relating to reuse of the generated data as compared with deletion of the internal caches generated in the external resource generation pass. Therefore, the internal caches generated in the external resource generation pass are deleted with priority in the modification example.

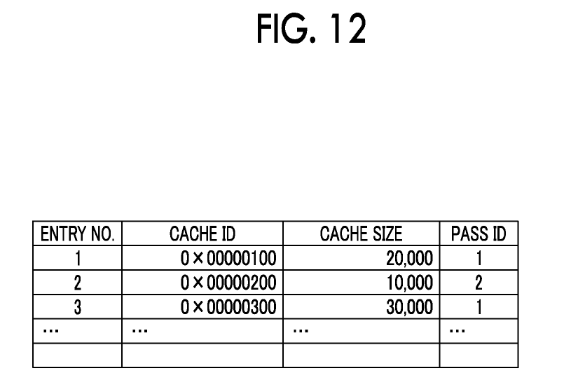

To control the deletion, the RIP module 100 generates a cache entry table (see FIG. 12) for managing caches in the cache memory 125 and manages the internal caches therein. The cache entry table illustrated in FIG. 12 includes four data items, namely an entry number (entry No.), a cache ID, a cache size, and a pass ID for each entry of the internal cache. The entry number is a sequential number of an order in which the internal cache is generated, and an entry with a smaller number is generated earlier. The cache size is a data size of the internal cache. The pass ID is identification information of the pass in which the internal cache is generated, and in this example, a pass ID “1” indicates the external resource generation pass while a pass ID “2” indicates the direct depiction pass.

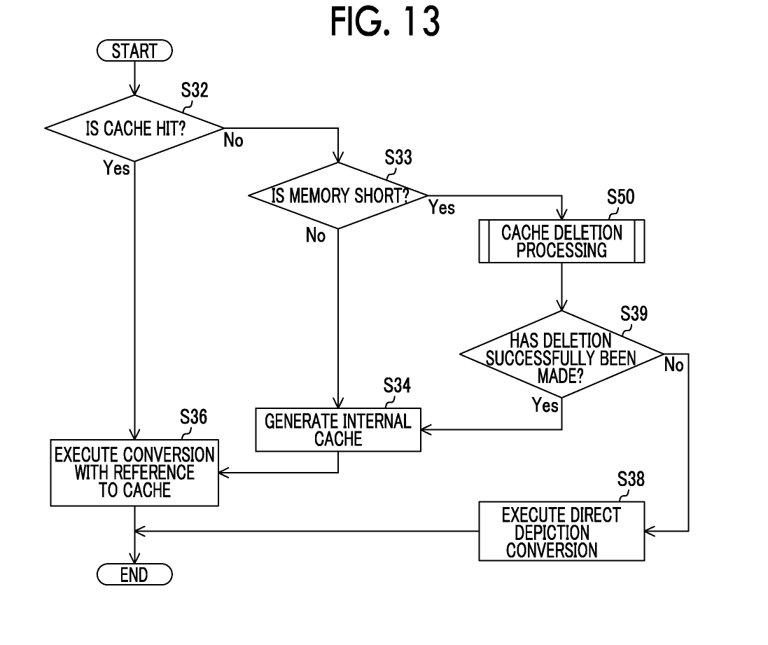

Referring to FIG. 13, a description will be given of an exemplary procedure for processing performed by the cache mechanisms in the direct depiction pass according to the modification example.

According to the procedure, the cache determination unit 131 determines whether or not an internal cache corresponding to an object input from the determination unit 106 is in the cache memory 125 (step S32). When a result of the determination in step S32 is Yes, the cache usage conversion unit 136 generates an external resource by reading the internal cache corresponding to the object from the cache memory 125 and further applying depiction parameters to the internal cache, and outputs the external resource to the post-processing unit 110 (step S36).

When the result of the determination in step S32 is negative (No), the cache generation unit 132 determines whether or not there is available capacity required for storing the internal cache of the object (step S33). Since information indicating the number of PDL commands configuring the object, an area of an image of the object, or the like is obtained from the result of interpreting the PDL of the object, for example, the data amount of the internal cache of the object may be estimated from such information. When the available capacity of the cache memory 125 is greater than the estimated value, it is not determined in step S33 that the capacity of the memory is insufficient (No). In such a case, the cache generation unit 132 generates the internal cache in the cache memory 125 (step S34). Then, the cache usage conversion unit 136 generates an external resource by applying a depiction parameter group to the internal cache (step S36). In the example illustrated in FIG. 13, it is considered that the generation of the internal cache (step S34) is not failed as long as the available capacity of the cache memory 125 is sufficient. However, when there is a case in which a failure is caused even when the available capacity is sufficient, a step S35 for checking whether the generation of the cache has been failed or successfully been made may be provided after step S34, and the direct depiction conversion (step S38) may be performed in a case of a failure in the same manner as in the procedure illustrated in FIG. 4.

When it is determined in step S34 that the available capacity of the cache memory 125 is insufficient (the result of the determination in step S33 is Yes), the cache management unit 133 deletes some internal caches in the cache memory 125 and tries to reserve necessary available capacity (step S50). Then, the cache management unit 133 determines whether or not necessary available capacity have been reserved by the deletion of the internal caches (step S39). When it is determined in step S39 that the necessary available capacity has been reserved (Yes), the processing proceeds to step S34, and the cache management unit 132 generates the internal cache of the object. When it is determined in step S39 that the necessary available capacity has not been reserved even when all the internal caches that may be deleted are deleted (No), the generation of the internal cache of the object is abandoned, and the conversion unit 138 directly converts the result of interpreting the PDL data by the interpretation unit 102 into intermediate data in the external format (step S38).

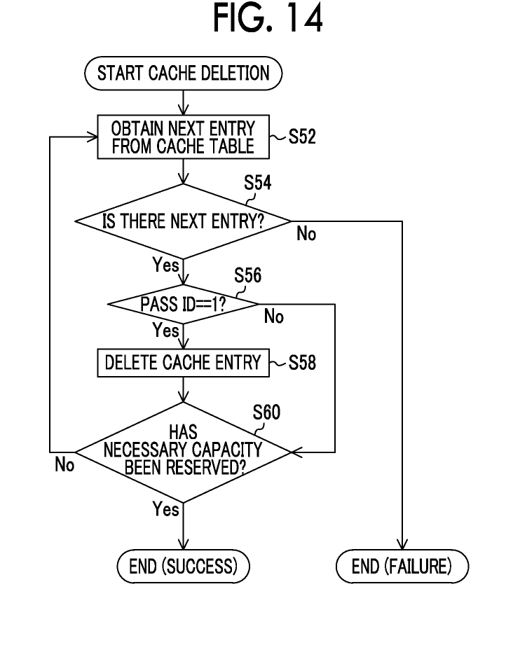

A description will be given of an example of specific processing in step S50 with reference to FIG. 14. In the processing illustrated in FIG. 14, the cache management unit 133 obtains the next entry in an order of the entry number from the cache entry table (see FIG. 12) (step S52). When the cache management unit 133 cannot obtain the next entry (a result of the determination in step S54 is No), a result of the processing is regarded as a “failure”, and the processing of deleting the caches is completed. When the next entry may be obtained (the result of the determination in step S54 is Yes), it is determined whether or not a pass ID of the entry is “1” (generation in the external resource generation pass) (step S56). When a result of the determination is Yes, data of the entry is recorded as a target of deletion from the cache memory 125 (step S58) (the data may not be deleted in practice at this timing). Then, the cache size (see FIG. 12) of the entry as the target of deletion is added to the available capacity of the cache memory 125. In doing so, the available capacity in a case of deleting the entry may be calculated. Then, it is determined whether or not the available capacity obtained by the calculation is equal to or greater than the estimated value of the data amount of the internal cache for the object (step S60). When a result of the determination in step S60 is No, the processing returns to step S52. When the result of the determination in step S60 is Yes, internal caches recorded as targets of deletion until then are deleted from the cache memory 125 and from the cache entry table, and the processing is completed.

The procedure illustrated in FIG. 14 is provided only for the illustrative purpose. In addition to the procedure, the internal caches generated in the external resource generation pass may be selected as targets of deletion with priority by taking pass IDs into consideration when cache entries as targets of deletion are selected by a deleted cache selection scheme in the related art, such as a least recently used (LRU) scheme.

Although the cache management unit 133 is provided only in the direct depiction pass in the example illustrated in FIG. 11, the same cache management unit may be provided in the cache mechanisms in the external resource generation pass, or the cache management units may be provided in both the passes instead.

In the example illustrated in FIG. 11, the cache memory 125 is shared by the external resource generation pass and the direct depiction pass. However, the control according to the modification example is also applicable to a case in which the individual cache memories 124 and 134 are provided in both the passes (see FIG. 7). When the cache memories 124 and 134 in both the passes are reserved on the same main memory of a computer that executes the RIP module 100 and available capacity of the main memory decreases, available spaces of the cache memories also decrease, and a new internal cache cannot be stored. When the internal caches stored in one of the two cache memories 124 and 134 are deleted in this case, the available capacity of the main memory increases, which brings about an increases in the available capacity of the cache memories and allows the new internal cache to be stored. In this example, the same cache entry table as that in FIG. 12 is commonly used by the two cache memories, and the respective cache generation units 122 and 132 register information of internal caches in the cache entry table when the internal caches are registered in the respective cache memories 124 and 134. Then, when it is determined that the available capacity of the cache memory 134 is insufficient (step S33 in FIG. 13), the cache management unit 133 determines internal caches as targets of deletion by the same determination method as that described above and deletes the internal caches from the cache memory 124 or 134 that stores the determined internal caches as the targets of deletion.

The same control as that in the modification example is also applicable to the RIP module 100 illustrated in FIG. 10. In such a case, it is only necessary for the cache generation unit 122 to register the value of the “direct” flag when the internal cache is generated, as a value of the pass ID for the internal cache in the cache entry table (see FIG. 12).

### Fifth Modification Example

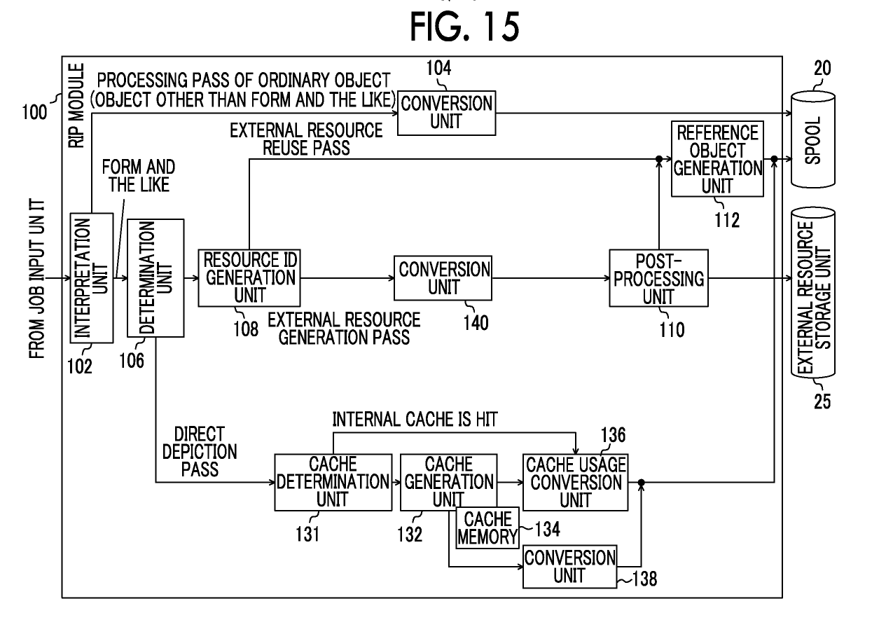

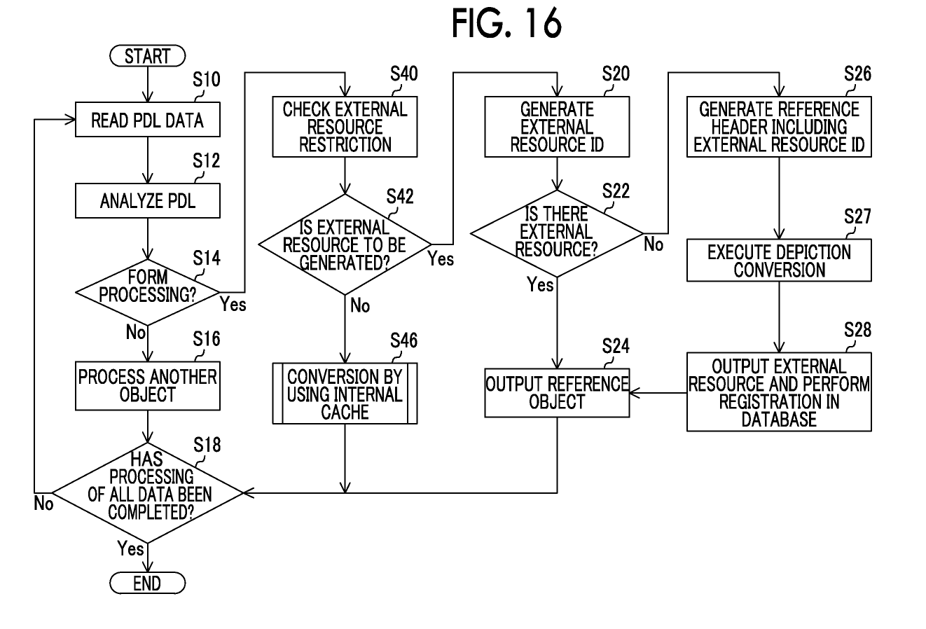

Next, a description will be given of a fifth modification example with reference to FIGS. 15 and 16.

As may be understood from comparison between FIG. 15 and FIG. 7, the cache mechanisms are not provided in the external resource generation pass, a conversion unit 140 is provided instead, and the cache mechanisms are provided in the direct depiction pass in this modification example.

The conversion unit 140 on the external resource generation pass directly converts the result of interpreting the PDL into data (external resource) in the external format by performing the same processing as that performed by the conversion unit 104. The post-processing unit 110 registers the external resource generated by the conversion unit 140 in the external resource storage unit 25 in association with the external resource ID generated by the resource ID generation unit 108. In addition, the reference object generation unit 112 generates a reference object in the external format, which instructs reference of the external resource ID, and outputs the reference object to the spool 20.

Functions of the cache mechanisms (the cache determination unit 131 to the conversion unit 138) on the direct depiction path are the same as those of the cache mechanisms (the cache determination unit 131 to the conversion unit 138) according to the second modification example described above with reference to FIG. 7.

FIG. 16 illustrates an exemplary procedure for processing performed by the RIP module 100 according to the modification example. The same reference numerals are given to the same steps in the procedure illustrated in FIG. 16 as those in the procedure according to the second modification example illustrated in FIG. 8, and the descriptions thereof will be omitted.

In the procedure illustrated in FIG. 16, the processing using the cache mechanisms on the external resource generation pass in the procedure illustrated in FIG. 8 (step S30) is replaced with depiction conversion from the PDL into the external format by the conversion unit 140 (step S27). In the direct depiction pass, the result of the conversion (internal cache) from the PDL into the internal format is reused by performing the conversion using the cache mechanisms (the cache determination unit 131 to the conversion unit 138) (step S46) in the same manner as in the procedure illustrated in FIG. 8.

In the related art, there is a system that performs the conversion from the PDL into the external format by portions corresponding to the external resource generation pass and the direct depiction pass, respectively, without using the cache mechanisms that store and reuse an internal cache. Such a system is disclosed in the related art. According to the system disclosed in the related art, intermediate data in a format with a rather low degree of abstraction (corresponding to the “external format”), to which various depiction parameters for printing, such as depiction attributes including coordinate conversion for rotation, enlargement, and reduction, for example, and a line width, clip information, and color information are applied, is stored in a cache and reused in a pass (processing route) (referred to as a “first pass”) for performing a specific type of object such as a form. When an advantage achieved by using an object does not meet the cost therefor, another processing pass (referred to as a “second pass”) is prepared. In the second pass, only conversion of the object into the external format is performed, and processing for storing the object in the cache and reusing the object is not performed. The first pass corresponds to the “external resource generation pass”, and the second pass corresponds to the “direct depiction pass”. In the system disclosed in the related art, data in the course of the processing is not stored in the cache and reused in both the first pass and the second pass. Although the system is configured such that data as a result of processing is stored and reused in the second generation pass, both data in the course of processing and data finally obtained (such as intermediate data) are not reused at all in the second pass. Therefore, when a large number of objects are assigned to the second pass, processing efficiency of the entire system is degraded.

In contrast, the system according to the fifth modification example is configured such that two-stage conversion from the PDL to the internal format and from the internal format to the external format is performed on the direct depiction pass and the data in the internal format in the course of the processing is stored in the cache mechanism and is reused. For this reason, the degradation in the processing efficiency is suppressed in the modification example even when a large number of objects are assigned to the direct depiction pass, for example.

The exemplary embodiment and the modification examples of the present invention are described hitherto. Although only the intermediate data format is exemplified as the external format in the exemplary embodiment and the modification examples, the methods according to the exemplary embodiments and the modification examples are also applicable to a case in which raster data is used as an external format.

The front-end device 10 (the RIP module 100 therein, in particular) according to the exemplary embodiment and the modification examples is realized by causing a computer to execute a program representing processing of the respective functional modules configuring the device, for example. Here, the computer includes, as hardware, a circuit configuration in which a microprocessor such as a CPU, a memory (primary storage) such as a random access memory (RAM) and a read only memory (ROM), an HDD controller for controlling a hard disc drive (HDD), various I/O (input/output) interfaces, and network interface for controlling connection with a network such as a local area network are connected via a bus. In addition, a disc drive for reading and/or writing in and/or from portable disc recording media such as a CD and a DVD, a memory reader writer for reading and/or writing from and/or in a potable non-volatile recording media of various standards such as a flash memory, and the like may be connected to the bus via an I/O interface, for example. A program describing the content of the processing of the aforementioned respective functional modules is saved in a fixed storage device such as a hard disc drive via a recording medium such as a CD or a DVD or via a communication mechanism such as a network, and is then installed in the computer. The aforementioned functional module group is realized by reading the program stored in the fixed storage device in the RAM and causing the microprocessor such as a CPU to execute the program. A part or an entirety of the functional module group may be configured as a hardware circuit such as a dedicated large scale integration (LSI), an application specific integrated circuit (ASIC), a field programmable gate array (FPGA), or a dynamic reconfigurable processor (DRP).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data processing apparatus comprising:
a first generation section that generates, based on a result of interpretation obtained by interpreting page description language data of a document element, first format data as data in a first format in relation to the document element and stores the generated first format data in a first storage section, the first generation section omitting generation of the first format data in relation to the document element when the first format data in relation to a same document element has already been stored in the first storage section; and
a second generation section that generates, based on the first format data in relation to the document element stored in the first storage section, second format data as data in a second format to which a number of depiction parameters larger than a number of depiction parameters of the first format data are applied and stores the generated second format data in a second storage section in association with the document element and identification information corresponding to a combination of the depiction parameters for reuse, the second generation section omitting generation of the second format data in relation to the combination when the second format data associated with the identification information corresponding to the combination has already been stored in the second storage section.

2. The data processing apparatus according to claim 1, further comprising:
a determination section that determines whether or not an input document element corresponds to a document element as a target of storage of the second format data, which is generated from the document element, in the second storage section and causes the first generation section and the second generation section to process the document element when a result of the determination is positive; and
a third generation section that generates, based on the result of interpretation obtained by interpreting the page description language data of the document element, the first format data in relation to the document element and stores the generated first format data in a third storage section when the result of the determination by the determination section is negative, the third generation section omitting generation of the first format data in relation to the document element, generating the second format data based on the first format data stored in the third storage section, and outputting the generated second format data when the first format data in relation to a same document element has already been stored in the third storage section.

3. The data processing apparatus according to claim 2,
wherein the first storage section and the third storage section are provided on a common memory, and
wherein the data processing apparatus further includes a deletion section that deletes the first format data generated by the first generation section from the common storage section prior to the first format data stored in the third generation section when available capacity of the first storage section or the third storage section becomes insufficient.

4. The data processing apparatus according to claim 2,
wherein the first storage section and the third storage section are provided as a common storage section.

5. The data processing apparatus according to claim 4, further comprising:
a deletion section that deletes the first format data generated by the first generation section from the common storage section prior to the first format data stored in the third generation section when available capacity of the common storage section becomes insufficient.

6. The data processing apparatus according to claim 1, further comprising:
a determination section that determines whether or not an input document element corresponds to a document element as a target of reuse, which is a target of storage of the second format data of the input document element in the second storage section for reuse,
wherein the second generation section stores the generate second format data in the second storage section when a result of the determination by the determination section is positive, and outputs the generated second format data without storing the second format data in the second storage section when the result of the determination by the determination section is negative.

7. The data processing apparatus according to claim 6, further comprising:
a deletion section that deletes the first format data corresponding to the document element as the target of reuse from the common storage section prior to the first format data corresponding to the document element that is not the target of reuse when available capacity of the first storage section becomes insufficient.

8. A data processing apparatus comprising:
a first section that generates external format data by interpreting page description language data of a document element and applying one or more depiction parameters determined in advance to a result of the interpretation and stores the generated external format data in an external data storage section in association with the document element and identification information corresponding to a combination of the depiction parameters for reuse, the first section omitting generation of the external format data in relation to the document element when the external format data in relation to a same document element has already been stored in the external data storage section;
a second section that generates external format data by interpreting page description language data of a document element and applying one or more depiction parameters determined in advance to a result of the interpretation and outputs the generated external format data without storing the external format data in the external data storage section; and
a determination section that determines whether or not an input document element corresponds to a document element as a target of storage of the external format data generated from the document element in the external data storage section, and causes the first section to process the document element when a result of the determination is positive, or causes the second section to process the document element when the result of the determination is negative,
wherein the second section includes:
an internal data generation section that generates, based on the result of the interpretation of the page description language data of the document element, internal format data to which a number of depiction parameters smaller than a number of depiction parameters of the external format data are applied, and stores the generated internal format data in an internal data storage section, the internal data generation section omitting generation of the internal format data in relation to the document element when the internal format data in relation to the document element has already been stored in the internal data storage section; and
a section that generates the external format data in relation to the document element by further applying depiction parameters to the internal format data in relation to the document element.

9. A non-transitory computer readable medium storing a program that causes a computer to function as:
a first section that generates external format data by interpreting page description language data of a document element and applying one or more depiction parameters determined in advance to a result of the interpretation and stores the generated external format data in an external data storage section in association with the document element and identification information corresponding to a combination of the depiction parameters for reuse, the first section omitting generation of the external format data in relation to the document element when the external format data in relation to a same document element has already been stored in the external data storage section;
a second section that generates external format data by interpreting page description language data of a document element and applying one or more depiction parameters determined in advance to a result of the interpretation and outputs the generated external format data without storing the external format data in the external data storage section; and
a determination section that determines whether or not an input document element corresponds to a document element as a target of storage of the external format data generated from the document element in the external data storage section, and causes the first section to process the document element when a result of the determination is positive, or causes the second section to process the document element when the result of the determination is negative,
wherein the second section includes:
an internal data generation section that generates, based on the result of the interpretation of the page description language data of the document element, internal format data to which a number of depiction parameters smaller than a number of depiction parameters of the external format data are applied, and stores the generated internal format data in an internal data storage section, the internal data generation section omitting generation of the internal format data in relation to the document element when the internal format data in relation to the document element has already been stored in the internal data storage section; and
a section that generates the external format data in relation to the document element by further applying depiction parameters to the internal format data in relation to the document element.
